(19) United States
(12) Patent Application Publication
(10) Pub. No.: US 2009/0192666 A1
(43) Pub. Date: Jul. 30, 2009

(54) DRIVER ASSISTANCE SYSTEM FOR LOCAL AND TIME ASSESSMENT AND PREDICTION OF THE DRIVING DYNAMICS OF A VEHICLE

(76) Inventor: Peter Trippler, Neu Anspach (DE)

Correspondence Address: BAKER BOTTS L.L.P.;PATENT DEPARTMENT, 98 SAN JACINTO BLVD., SUITE 1500, AUSTIN, TX, 78701-4039, US

(21) Appl. No.: 12/438,229

(22) PCT Filed: May 25, 2007
(86) PCT No.: PCT/EP2007/055127

§ 371 Date: Feb. 20, 2009

(30) Foreign Application Priority Data
Aug. 21, 2006 (DE) 10 2006 039 183.7

(51) Int. Cl. G08G 1/16

(52) U.S. Cl. 701/29; 701/117

(57) ABSTRACT

The invention relates to a driver assistance system for local and time assessment and prediction of the driving dynamics of a vehicle within a traffic system and to the transmission of the information resulting thereof to neighboring vehicles. According to the invention, the data generated independently from each other in the vehicle to be assessed is collected and evaluated in an evaluation unit, and a prediction based thereon regarding an upcoming driving situation is generated and then transmitted to motor vehicles that are located in the surrounding area and involved in said driving situation.

The invention relates to a driver assistance system for local and time assessment and prediction of the driving dynamics of a vehicle within a traffic system and to the transmission of the information resulting therefrom to neighboring vehicles.

In dense road traffic, the action of one vehicle can lead to an unintentional reaction by other road users. This reaction can lead to critical situations, especially if the original action was not detected in good time by other vehicle drivers. Such actions are especially, but not exclusively, limited to maneuvers such as changing lanes, suddenly turning off or violently braking. The desire to increase safety in road traffic by transmitting information from vehicle to vehicle has existed for a long time and is becoming more urgent with increasing traffic density.

From DE 199 15 935 C2, a transmitting device for the transmission of data signals in a traffic system is known for this purpose, with the transmitting device having at least one light source for radiating a light signal, which contains a data signal. The light source is a lighting unit of a vehicle, especially a headlight and/or a brake light.

Furthermore, from DE 196 25 960 C2 a device for the transmission of information from a preceding vehicle to a following vehicle is known, with a transmitter in the preceding vehicle which transmits pulsed light signals imperceptible to the human eye, with a receiver in the following vehicle which receives and evaluates the light signals transmitted by the transmitter and with at least one light-emitting diode as a transmitter. In this case, the light-emitting diode transmits the pulsed light signals, at a frequency imperceptible to the human eye and in the visible wave range, which can be detected by the receiver, with the light signal being formed depending on the actual deceleration or acceleration and a switching device which regulates the strength and/or frequency of the transmitter relative to the magnitude of the deceleration or acceleration.

Furthermore, local systems are known which have an anticipatory effect. These particularly include lane estimation for distance-controlled cruise control (ACC) systems. In automatic speed and distance control systems for detecting the traffic situation, it is normal to predict a driving corridor with the aid of signals from yaw rate sensors or transverse acceleration sensors. This means that the point at which the vehicle will stop after a predetermined time period is determined as is also which preceding vehicles are stopping in the driving corridor of the own vehicle.

The driving corridor in this case is determined from the curve radius of the vehicle, which in turn is derived from the vehicle speed and the signal from the yaw rate sensor. The use of the yaw rate sensor does not provide sufficient information regarding the driving dynamics of the motor vehicle. Additional sensors are required for this purpose.

Furthermore, a method for the anticipatory determination of the driving corridor of a motor vehicle for an automatic distance control system is known from DE 197 49 306 A1, with which a signal corresponding to the speed is used to determine a curve radius of the motor vehicle, with the driving corridor being determined from the curve radius. For a precise determination of the driving corridor of the motor vehicle, the wheel speed of at least two vehicle wheels is measured and the yaw rate of the vehicle is determined from the difference between both wheel speeds, in order to adequately take account of the driving dynamics of the motor vehicle.

A disadvantage of these systems is that they assess only a few data sources and furthermore only in the particular overall system (e.g. ACC), but nothing more than that and cannot be used without specific knowledge of the signal processing.

The object of this invention is to provide a driver assistance system that is designed as an evaluation unit of vehicle-inherent data and from this data makes a prediction with respect to the anticipated traffic situation and transmits this information to vehicles in the immediate vicinity.

This object is achieved by means of a driver assistance system with the features of claim 1. Advantageous embodiments and developments, which can be used either individually or in combination with each other, are the subject matter of the dependent claims.

The inventive driver assistance system for local and time evaluation and prediction of the driving dynamics of a vehicle within a traffic system and for the transmission of the information resulting therefrom to neighboring vehicles is characterized in that items of data generated independently from each other in the vehicle to be assessed are collected and evaluated in an evaluation unit and a prediction based thereon regarding an upcoming driving situation is generated and then transmitted to vehicles in the surrounding area which are involved in said driving situation. From the determined data, the driving or surrounding situation can be assessed, for example for an entry to a building site. Furthermore, the data from the sensors can be used for a plausibility check of other sensors.

The object of the invention is to inform the surrounding traffic of one's own intentions or observations, in order to enable said surrounding traffic, if it is equipped with devices for receiving the transmitted data, to be able to react earlier to a situation than with previous systems. By the fusion of data regarding driving dynamics and navigation data, environment data and other data which describes the situation, the developing driving situation can be detected and evaluated at its onset with great accuracy. By means of the fusion of several data sources, both the quality of the prediction and the certainty of the prediction with regard to driver intentions can be increased. It is thus possible for the first time to transmit this data, determined with high precision, to other road users, in order to achieve an improved driving situation without having to take account of uncomfortable reactions. Accordingly, this invention has a central evaluation unit for all the data sources present in the vehicle, with respect to driving dynamics, environment sensors, navigation and other data sources which influence or characterize the status, which from this data generates a prediction of the driving dynamics of the vehicle. Examples of data sources which affect the driving dynamics can be the rotational speed of the wheels, spring travel, tire air pressure, braking or engine data, inertia data, which affects the acceleration or rates of rotation or the route planning, with this, however, not being a complete list. Data sources for the environment sensors are for example, rain or temperature sensors, door sensors and sliding roof sensors or sensors which determine the location or relative speed of objects outside the vehicle. As a data source for the navigation system, position sensors are used which define the position of the vehicle in three-dimensional space, Furthermore, sensors are conceivable which detect or perceive an aggressive or defensive driving behavior or an alert or sleepy driver state, or whether a trailer is being pulled by the vehicle.

It is provided according to the invention that the predicted driving situation is transmitted to vehicles in the immediate vicinity. Because the determination of driving states or driving intentions is anticipatory, the vehicles participating as receivers can be informed of the status of the transmitting vehicle before a driver or sensors in the neighboring vehicles can detect these. By means of the prediction, surrounding vehicles fitted with a device for receiving and processing can react early to a developing situation and thus prevent any impairment or danger to their own vehicles and thus increase driving comfort. Further advantages are that the risk of accidents or consequences of unavoidable accidents are minimized, fuel consumption is reduced by an anticipatory driving mode and the number of sensors required for plausibility checking is kept low.

It is preferred that the transmission of information to neighboring vehicles takes place by optical means. If light-emitting diodes are used in a transmitting device, the coded light signals can also be transmitted at a frequency imperceptible to the eye. In this respect, further information, such as braking information, speed or distance information can in this case also be transmitted to the following vehicle. Without the vehicle driver being distracted, the vehicle determines information relevant for safety which it then passes on to the driver as required. In doing so, it is possible to operate in the wavelength visible to the human eye using the light-emitting diodes in brake lights already used in the vehicle industry, so that a cost-effective introduction of this system can take place even though these light-emitting diodes do not have an infrared component.

A further advantageous transmission possibility is that the transmission of information to neighboring vehicles can take place using microwaves. In this case, the transmission devices for the transmission of data signals in a traffic system are based on a transmission device which has at least one light source for radiating a light signal containing a data signal. The light signal consists of an infrared signal and therefore the light source of this known transmission device is an infrared light source. It is advantageous if the light source for radiating a data signal is a lighting unit of the vehicle, especially a headlamp and/or a brake light. This enables direct communication on the part of the vehicles and also between the vehicles, but cleverly uses the existing lighting units on the vehicle so that an additional separate signal source is not necessary.

It is furthermore preferred if the transmission of information to neighboring vehicles takes place by using local devices, especially of the GSM networks.

The transmission of information to neighboring vehicles can advantageously also take place using acoustic methods. This can, for example, be by means of ultrasound as is known for the remote control of television sets or by using existing systems such as the parking distance measurement system. It is also conceivable to use a piezo transmitter as a loudspeaker in the rear bumper and a receiver (microphone) in the front bumper. The data transfer can take place by means of frequency or amplitude modulation.

For the first time, this invention advantageously provides a driver assistance system for local and time assessment and the prediction of the driving dynamics of a vehicle within a traffic system and for the transmission of the information resulting therefrom to neighboring vehicles so that the fuel consumption is reduced, driving comfort increased and, in addition, the danger of accidents is avoided or their consequences reduced.

Further advantages and embodiments of the invention are shown by means of exemplary embodiments and with the aid of drawings.

The drawings are schematic views as follows:

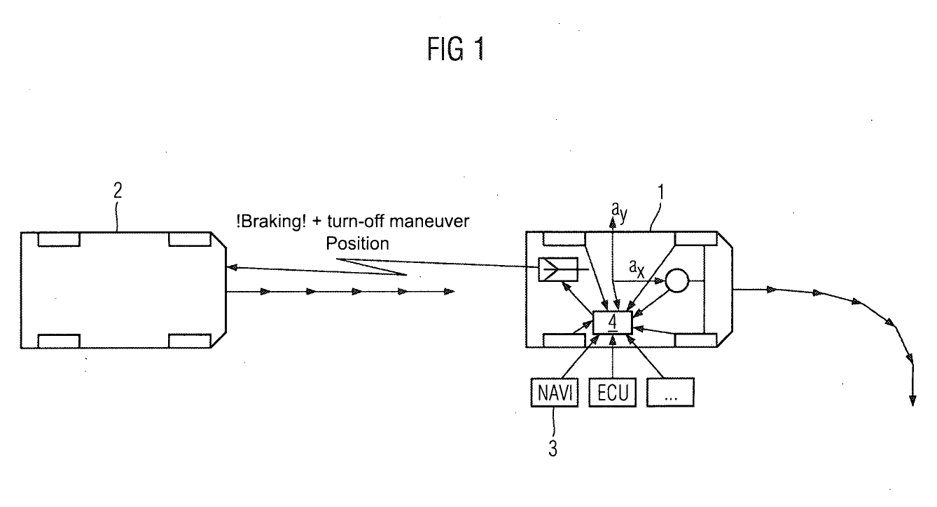

FIG. 1A driving situation which is characteristic of a turn-off maneuver;

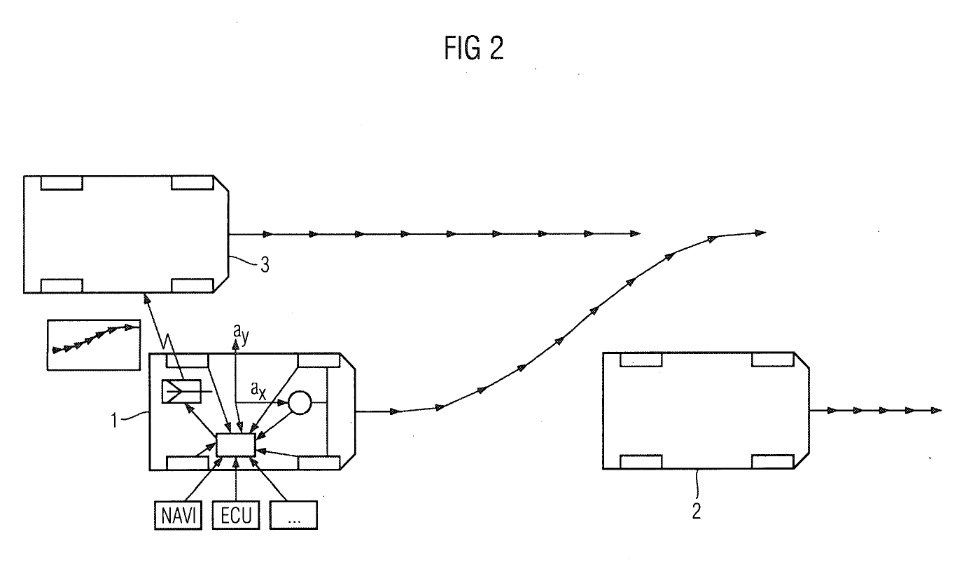

FIG. 2 A driving situation which is characteristic of a lane change;

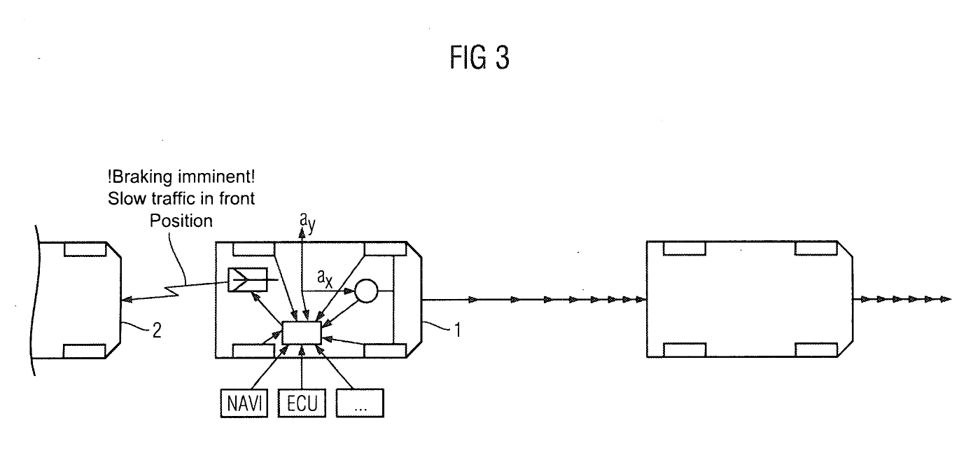

FIG. 3 A driving situation which is characteristic of a sudden braking operation;

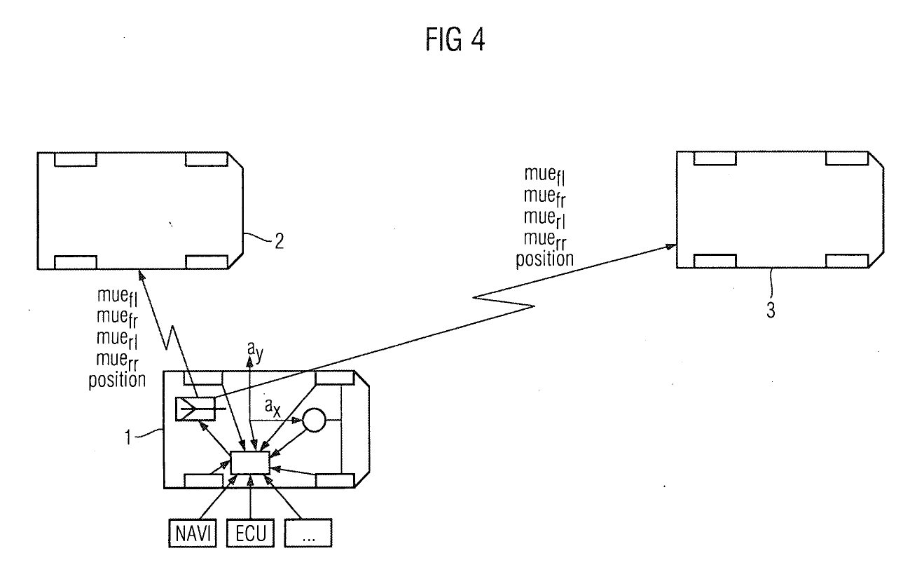

FIG. 4 A driving situation which is characteristic of an unstable driving state.

FIG. 1 shows a driving situation which is characteristic of a turn-off maneuver. A preceding vehicle 1, which is followed by a following vehicle 2 and is about to initiate a turn-off maneuver can, before the driver of the preceding vehicle 1 applies the direction indicator, signal, according to the invention by a satellite-aided navigation system 3, to the vehicles that are located in the immediate vicinity and are also involved in this traffic situation that vehicle 1 is about to reduce speed. It is also an intrinsic feature of the invention that in the event of a lane change environmental sensors signal said lane change to the surrounding traffic. According to the invention, the items of data generated independently from each other is collected and evaluated in an evaluation unit 4, and a prediction based thereon regarding an upcoming driving situation is generated and then transmitted to motor vehicles that are located in the surrounding area and are involved in this driving situation. Accordingly, a turn-off maneuver is not firstly detected by optical signals, such as a direction indicator, by the driver of the vehicle following the vehicle turning off. The result of this is an early reduction in the speed of the following vehicle, thus minimizing the risk of accident and also reducing fuel consumption.

FIG. 2 shows a driving situation which is characteristic of a lane change. There are three vehicles on a highway with at least two lanes, with the vehicle 1 performing the lane change positioned behind a preceding vehicle 2 in the same lane and in front of a following vehicle 3 in the other lane. A lane change can, for example, be detected in that a heavy braking must be performed if remaining in the previous lane. Furthermore, on the basis of the evaluation of driving dynamics data, such as the yaw rate, an upcoming lane change can be inferred, with it being possible in this case to use a satellite-aided navigation system for plausibility checking. The invention envisages that vehicles on the target highway are provided with early information of a lane change operation and their behavior can be accordingly adapted, thus reducing the risk of accidents and reducing fuel consumption, in that late braking can be avoided. FIG. 3 shows a driving situation which is characteristic of a sudden braking operation. Three vehicles are moving in one direction within a lane, with the vehicle 1 positioned in the center being able to detect a heavy braking operation at the onset by means of environment sensors, which means that a possible accident risk is minimized. This information is transmitted to a following vehicle 2 which in turn can initiate the braking operation earlier by carrying out a possible lane change earlier. The probability of an accident is thus minimized in that the braking distance is shortened.

FIG. 4 shows a driving situation which is characteristic of an unstable driving state. The starting point for this driving situation is that the on-board systems of a vehicle 1 detect an unstable vehicle state. On-board autonomous processing units, such as vehicle state determination devices, can be used for this purpose. It is thus possible to determine whether the unstable vehicle state is due to local circumstances, such as a defect on the vehicle, or to external influences such as a locally reduced coefficient of friction. By means of the inventive driver assistance system, the vehicles 2, 3 in the vicinity can be warned.

This invention advantageously provides for the first time a driver assistance system for local and time assessment and prediction of the driving dynamics of a vehicle within a traffic system and for the transmission of the information resulting therefrom to neighboring vehicles, which reduces the fuel consumption, increases the driving comfort and additionally avoids the danger of accidents or reduces their consequences.

1. A driver assistance system for local and time assessment and prediction of the driving dynamics of a vehicle within a traffic system and for the transmission of the information resulting therefrom to neighboring vehicles, characterized in that the items of data generated independently from each other in the vehicle to be assessed are collected in an evaluation unit, and a prediction based thereon regarding an upcoming driving situation is generated, which is then passed to vehicles that are located in the surrounding area and are involved in said driving situation.

2. The driver assistance system as claimed in claim 1, characterized in that the data is generated by sensors for the driving dynamics and/or for the navigation and/or for the environment and/or for the driving-specific behavior and/or for the driving-specific state.

3. The driver assistance system as claimed in claim 1 or 2, characterized in that the wheel speed and/or the braking or engine status and/or inertia data and/or spring travel and/or tire pressure are determined for the driving dynamics.

4. The driver assistance system as claimed in one of the preceding claims, characterized in that rain sensors and/or temperature sensors and/or door sensors and/or sensors determining the location and relative speed of objects outside the own vehicle are used for determining the environment.

5. The driver assistance system as claimed in one of the preceding claims, characterized in that the transmission of the information to neighboring vehicles takes place by optical means.

6. The driver assistance system as claimed in one of the preceding claims, characterized in that the transmission of the information to neighboring vehicles takes place by microwave means.

7. The driver assistance system as claimed in one of the preceding claims, characterized in that the transmission of the information to neighboring vehicles takes place by using local devices, especially by means of GSM networks.

8. The driver assistance system as claimed in one of the preceding claims, characterized in that the transmission of the information to neighboring vehicles takes place by acoustic means.
